(19) United States
(12) Patent Application Publication
(10) Pub. No.: US 2026/0289970 A1
(43) Pub. Date: Sep. 24, 2026

(54) TATTOO CLASSIFICATION AND RECOGNITION METHOD, APPARATUS, DEVICE AND MEDIUM

(71) Applicant: Tianmian Information Technology (Shenzhen) Co., Ltd., Shenzhen (CN)

(72) Inventors: Cheng Shao, Shenzhen (CN); Huanming Wu, Shenzhen (CN)

(21) Appl. No.: 19/243,018

(22) Filed: Jun. 19, 2025

(30) Foreign Application Priority Data
Mar. 20, 2025 (CN) 202510333747.7

(51) Int. Cl. G06V 10/764; G06V 10/26; G06V 10/34; G06V 10/46; G06V 10/54; G06V 10/70

(52) U.S. Cl. CPC G06V 10/765; G06V 10/26; G06V 10/34; G06V 10/467; G06V 10/54; G06V 10/87

(57) ABSTRACT

The present invention discloses a tattoo classification and recognition method, including: performing type annotation on acquired skin image data to obtain skin type images; determining skin appearance features of the skin images to be recognized according to the skin type images; performing pointwise convolution and depthwise convolution on the skin images to obtain a tattoo probability of each skin image; if the tattoo probability of a skin image is less than or equal to a preset probability threshold, obtaining a judgment result that the skin image is not a tattoo; if the tattoo probability of a skin image is greater than the probability threshold, converting the skin image into a sequence of the skin to be recognized; and performing feature recognition on the sequence using a tattoo classification label to obtain a tattoo classification result. The present invention improves the tattoo classification and recognition accuracy.

### CROSS REFERENCE TO RELATED APPLICATIONS

The present application claims the benefit of Chinese Patent Application No. 202510333747.7 filed on Mar. 20, 2025, the contents of which are incorporated herein by reference in their entirety.

### TECHNICAL FIELD

The present application relates to the technical field of image recognition, and more particularly, to a tattoo classification and recognition method, an apparatus, a device, and a medium.

### BACKGROUND

In existing technologies, the quality of tattoo images is affected by numerous factors, including shooting angle, lighting conditions, variations in body posture, image resolution, and background interference. These variable factors result in significant performance differences of tattoo images across different environments, thereby increasing the recognition difficulty for deep learning models. Tattoo images typically possess complex backgrounds, where objects and light/shadow variations in the background may interfere with model recognition, consequently affecting accuracy. Furthermore, deep learning models rely on large amounts of annotated data during training. However, in many practical application scenarios, particularly in the financial services sector, tattoo image samples are relatively scarce. Different types of tattoos may exhibit substantial class imbalance issues, causing models during training to favor recognizing more frequently occurring categories while neglecting rarer tattoo types, ultimately impairing the accuracy of tattoo classification and recognition.

Current existing technologies present the problem of relatively low accuracy in tattoo classification and recognition.

### SUMMARY

The present application provides a tattoo classification and recognition method, apparatus, device, and medium, the main objective of the present application is to solve the problem of low accuracy in tattoo classification and recognition.

In a first aspect, the present application provides a tattoo classification and recognition method, the method including:
acquiring a plurality of types of skin image data, and performing type annotation on the skin image data to obtain skin type images;
acquiring a plurality of skin images to be recognized, and determining skin appearance features of the skin images to be recognized according to the skin type images;
selecting a feature extraction algorithm of the skin images to be recognized according to the skin appearance features;
performing pointwise convolution and depthwise convolution on the skin image to be recognized according to the selected feature extraction algorithm to obtain a tattoo probability of each skin image to be recognized;
if the tattoo probability is less than or equal to a preset probability threshold, obtaining a judgment result that the skin type of the skin image to be recognized, of which the tattoo probability is less than or equal to the probability threshold, is not a tattoo;
if the tattoo probability is greater than the probability threshold, converting the skin images to be recognized with a tattoo probability of being greater than the probability threshold into a sequence of the skin to be recognized; and
acquiring a tattoo classification label, and performing feature recognition on the sequence of the skin to be recognized using the tattoo classification label to obtain a tattoo classification result.

In a second aspect, the present application further provides a tattoo classification and recognition apparatus including:
an image annotation module configured to acquire a plurality of types of skin image data, and performing type annotation on the skin image data to obtain skin type images;
a feature determination module configured to acquire a plurality of skin images to be recognized, and determining skin appearance features of the skin images to be recognized according to the skin type images;
an algorithm selection module configured to select a feature extraction algorithm of the skin images to be recognized according to the skin appearance features;
an image convolution module configured to perform pointwise convolution and depthwise convolution on the skin image to be recognized according to the selected feature extraction algorithm to obtain a tattoo probability of each skin image to be recognized;
a first judgment result execution module configured to, if the tattoo probability is less than or equal to a preset probability threshold, obtaining a judgment result that the skin type of the skin image to be recognized, of which the tattoo probability is less than or equal to the probability threshold, is not a tattoo;
a second judgment result execution module configured to, if the tattoo probability is greater than the probability threshold, converting a skin image to be recognized which is greater than the probability threshold into a sequence of the skin to be recognized; and
a classification and recognition module configured to acquire a tattoo classification label, and performing feature recognition on the sequence of the skin to be recognized using the tattoo classification label to obtain a tattoo classification result.

In a third aspect, the present application further provides an electronic device including:
at least one processor; and
a memory communicatively connected to the at least one processor; where

the memory stores a computer program executable by the at least one processor, the computer program being executed by the at least one processor to enable the at least one processor to perform the tattoo classification and recognition method described above.

In a fourth aspect, the present application further provides a computer-readable storage medium having stored therein at least one computer program for execution by a processor in an electronic device to implement the tattoo classification and recognition method as described above.

In the present application, the accuracy of tattoo classification and recognition is effectively improved by acquiring a plurality of types of skin image data, and performing type annotation on the skin image data to obtain skin type images; acquiring a plurality of skin images to be recognized, and determining skin appearance features of the skin images to be recognized according to the skin type images; selecting a feature extraction algorithm of the skin images to be recognized according to the skin appearance features; performing pointwise convolution and depthwise convolution on the skin image to be recognized according to the selected feature extraction algorithm to obtain a tattoo probability of each skin image to be recognized; if the tattoo probability is less than or equal to a preset probability threshold, obtaining a judgment result that the skin type of the skin image to be recognized, of which the tattoo probability is less than or equal to the probability threshold, is not a tattoo; if the tattoo probability is greater than the probability threshold, converting the skin images to be recognized with a tattoo probability of being greater than the probability threshold into a sequence of the skin to be recognized; and acquiring a tattoo classification label, and performing feature recognition on the sequence of the skin to be recognized using the tattoo classification label to obtain a tattoo classification result.

### BRIEF DESCRIPTION OF THE ACCOMPANYING DRAWINGS

In order to explain the embodiments of the present application or the technical solutions in the prior art more clearly, a brief description will be given below of the drawings which need to be used in the embodiments. It is obvious that the drawings in the following description are only some embodiments of the present application, and it would have been obvious for a person skilled in the art to obtain other drawings according to these drawings without involving any inventive effort.

FIG. 1 is a schematic flowchart of a tattoo classification and recognition method according to an embodiment of the present application.

FIG. 2 is a block diagram showing a tattoo classification and recognition apparatus according to an embodiment of the present application;

FIG. 3 is a schematic structural diagram showing an electronic device implementing a tattoo classification and recognition method according to an embodiment of the present application; and

FIG. 4 is another schematic structural diagram showing an electronic device implementing a tattoo classification and recognition method according to an embodiment of the present application.

The objects, features and advantages of the present application will be further described referring to the accompanying drawings in conjunction with the embodiments.

### DETAILED DESCRIPTION OF ILLUSTRATED EMBODIMENTS

To enable a person skilled in the technical field to better understand the technical solutions of the present disclosure, and to fully comprehend how the present disclosure applies technical means to solve technical problems while achieving corresponding technical effects for implementation, the technical solutions in the embodiments of the present disclosure will be clearly and completely described below in conjunction with the accompanying drawings in the embodiments of the present disclosure. It is evident that the described embodiments are only a part of the embodiments of the present disclosure, rather than all of them. The embodiments of the present disclosure and the various features in the embodiments may be combined with one another without conflict, and all the technical solutions formed thereby fall within the protection scope of the present disclosure. Based on the embodiments of the present disclosure, all other embodiments obtained by a person skilled in the art without creative efforts shall fall within the protection scope of the present disclosure.

It should be noted that the terms “first”, “second,” and the like in the specification and claims of the present disclosure and the above-mentioned drawings are configured to distinguish similar objects and are not necessarily configured to describe a specific sequence or order. It should be understood that the data used in this way may be interchanged under appropriate circumstances, so that the embodiments of the present disclosure described herein can be implemented in sequences other than those illustrated or described herein. Furthermore, the terms “including” and “having” and any variations thereof are intended to cover non-exclusive inclusion. For example, a process, method, apparatus, product, or device that contains a series of steps or units is not necessarily limited to those steps or units that are clearly listed, but may include steps or units that are not explicitly listed or are inherent to such processes, methods, products, or devices.

The embodiments of the present application provide a tattoo classification and recognition method, wherein the execution entity of the tattoo classification and recognition method includes, but is not limited to, at least one of electronic devices such as a server or a terminal that can be configured to execute the apparatus provided by the embodiments of the present application. In other words, the tattoo classification and recognition method may be executed by software or hardware installed on terminal devices or server devices. The server includes, but is not limited to: a single server, a server cluster, a cloud server, or a cloud server cluster, etc. The server may be an independent server or a cloud server that provides basic cloud computing services such as cloud service, cloud database, cloud computing, cloud function, cloud storage, network service, cloud communication, middleware service, domain name service, security service, Content Delivery Network (CDN), as well as big data and artificial intelligence platforms.

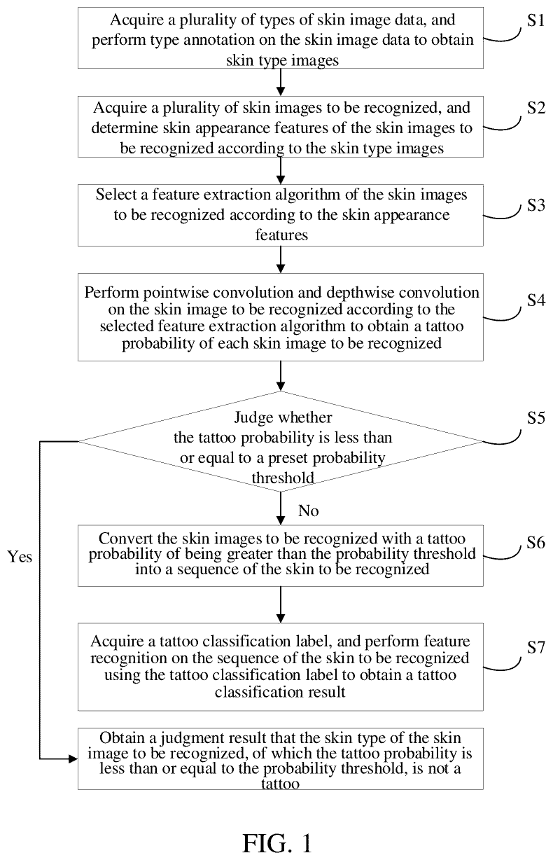

Referring to FIG. 1, there is shown a schematic flowchart of a tattoo classification and recognition method according to an embodiment of the present application. In the present embodiment, the tattoo classification and recognition method includes:

S1 Acquire a plurality of types of skin image data, and perform type annotation on the skin image data to obtain skin type images.

In the embodiments of the present application, through, for example, publicly available skin datasets, medical image libraries, skin disease databases, or by actually collecting skin image data, multiple types of skin image data including: image data of tattoos, scars, and normal skin, the type annotation for skin image data such as tattoos, scars, and mixed features, skin type images with detailed annotations are obtained.

In detail, the performing type annotation on the skin image data to obtain skin type images includes:
the skin image data are converted into a skin grayscale image;
the skin grayscale image is performed Gaussian smoothing to obtain a smoothed grayscale image;
a horizontal gradient and a vertical gradient of each pixel in the smoothed grayscale image are calculated;
a gradient magnitude and a gradient direction are calculated using the horizontal gradient and the vertical gradient;
it is judged whether the gradient magnitude of each pixel in the smoothed grayscale image is greater than a preset first threshold one by one in the gradient direction;
if the gradient magnitude of the pixel is greater than the preset first threshold, the pixel of which the gradient magnitude is greater than the first threshold is taken as a strong edge;
if the gradient magnitude of the pixel is less than or equal to the first threshold, it is judged whether the gradient magnitude is less than a preset second threshold;
if the gradient magnitude is less than the second threshold, the pixel of which the gradient magnitude is less than the second threshold is deleted;
if the gradient magnitude is greater than or equal to the second threshold, it is judged whether an adjacent pixel of the pixel of which the gradient magnitude is greater than or equal to the second threshold is the strong edge;
if the adjacent pixel is not the strong edge, the pixel of which the gradient magnitude is greater than or equal to the second threshold is deleted;
if the adjacent pixel is the strong edge, the pixel of which the gradient magnitude is greater than or equal to the second threshold is taken as a weak edge;
an OR operation is performed on the strong edge and the weak edge to obtain a skin feature edge; and

an annotation rule and a skin type label are acquired, and the skin feature edge is recognized and marked using the annotation rule and the skin type label to obtain skin type images.

In detail, the skin image data is converted into the skin grayscale image, and the calculation formula is as follows: Gray=0.2989×R+0.5870×G+0.1140×B, R, G, and B respectively represent pixel values of red, green and blue channels in the skin image data, and original pixel values in the skin image data are replaced with the calculated grayscale values to obtain the skin grayscale image, and brightness information about the image is retained.

In detail, the performing Gaussian smoothing on the skin grayscale image to obtain a smoothed grayscale image includes:
one pixel of the skin grayscale image is randomly selected as a first target pixel;
the adjacent pixel of the first target pixel is taken as a second target pixel;
pixel values of the first target pixel and the second target pixel are performed weighted averaging using a preset Gaussian filter to obtain an updated pixel value; and
a smoothed grayscale image is generated using the updated pixel value.

In detail, the Gaussian filter is a filter based on the Gaussian function (normal distribution function), which assigns weights to pixel values in the skin grayscale image, and the calculation formula is as follows:

$$D ( p , q ) = \frac{1}{2 {πσ}^{2}} exp ( - \frac{{p}^{2} + {q}^{2}}{2 {σ}^{2}} )$$

where σ represents a standard deviation of pixel values of the skin grayscale image, and (p, q) represents the pixels in the skin grayscale image. According to the above-mentioned formula, calculating the weight of each pixel in the skin grayscale image, and the pixel values of the first target pixel and the second target pixel are performed the weighted averaging to obtain the updated pixel value, where the calculation formula is as follows:

$${I}^{′} = {\sum }_{p , q} I ( p , q ) * D ( p , q )$$

where I(p, q) represents the second target pixel, D(p, q) represents the Gaussian weight, and I′represents the updated pixel value.

In detail, the horizontal gradient and the vertical gradient of each pixel in the smoothed grayscale image are calculated, and the calculation formula is as follows:

$${A}_{m} = {\sum }_{i , j} {S}_{m} * I ( i , j )$$

$${A}_{n} = {\sum }_{i , j} {S}_{n} * I ( i , j )$$

where Aₘ represents the horizontal gradient, Aₙ represents the vertical gradient, Sₘ represents the gradient operator in the horizontal direction, Sₙ represents the gradient operator in the vertical direction, and I(i, j) represents each pixel in the smoothed grayscale image.

In detail, the gradient magnitude and the gradient direction are calculated using the horizontal gradient and the vertical gradient, and the calculation formula is as follows:

$$A = \sqrt{{A}_{m}^{2} + {A}_{n}^{2}}$$

$$θ = ar tan 2 ( {A}_{n} , {A}_{m} )$$

where Aₘ represents the horizontal gradient, Aₙ represents the vertical gradient, A represents the gradient magnitude, and θ represents the gradient direction.

In detail, the annotation rules are configured to define how to distinguish different skin type labels, including: textures in the image, skin tone, etc. The skin type labels include: normal skin (e.g., healthy skin without any lesions), tattoo (tattoo patterns on the skin), scar (scars after skin injury), and mixed features, etc. For instance, if the skin feature edge exhibits no obvious texture and the skin tone is normal, it is labeled as normal skin; if the skin feature edge displays noticeable texture while the skin tone remains normal, it is labeled as suspected tattoo, among other classifications.

By employing Gaussian smoothing and gradient detection methods, edge features within skin images are effectively extracted, aiding in the accurate identification and labeling of skin types. Gaussian smoothing reduces image noise while preserving important structural features of the image. By calculating the gradient magnitude and direction for each pixel, strong and weak edges in the image can be precisely recognized, which assists in more finely delineating skin details and textures. By concatenating together these edge features and combining them with skin type labeling rules, highly precise and interpretable skin type images can be generated, which provides a reliable foundation for subsequent skin analysis and classification.

S2 Acquire a plurality of skin images to be recognized, and determine skin appearance features of the skin images to be recognized according to the skin type images.

In the embodiments of the present application, the similarity between the skin image to be recognized and the known skin type image is calculated by means of the similarity measurement method of cosine similarity, and the skin appearance feature of the skin image to be recognized are determined according to the similarity.

In detail, the determining skin appearance features of the skin images to be recognized according to the skin type images includes:
the skin type image is converted into the skin type image vector;
the skin image to be recognized is converted into the skin image vector to be recognized;
the skin type image vector and the skin image vector to be recognized are multiplied to obtain the first multiplication result;
the modulus of the skin type image vector and the skin image vector to be recognized are respectively calculated to obtain the first modulus result and the second modulus result;
the first module result and the second module result are multiplied to obtain the second multiplied result;
the first product result is divided by the second product result to obtain a skin type similarity;
skin type images corresponding to cases where the skin type similarity is greater than a preset similarity threshold is screened out; and
the skin appearance features of the skin image to be recognized corresponding to the screened skin type image are generated according to the screened skin type image.

In detail, the skin type similarity between the skin image to be recognized and the known skin type image is calculated by means of the similarity measurement method of cosine similarity, and the calculation formula is as follows:

$$Cosine Similarity = \frac{x * u}{‖ x ‖ ‖ u ‖}$$

where x represents the skin image to be recognized, and u represents the skin type image.

skin type images corresponding to cases where the skin type similarity is greater than a preset similarity threshold is screened out, and the appearance feature of the skin type corresponding to the skin type image is generated according to the annotation rule of the skin type image to obtain the skin appearance feature of the skin image to be recognized which is similar to the skin type image. The annotation rule is the annotation rule in step S1, for instance, if the skin feature edge exhibits no obvious texture and the skin tone is normal, it is labeled as normal skin; if the skin feature edge displays noticeable texture while the skin tone remains normal, it is labeled as suspected tattoo, among other classifications.

By converting the image into a vector and calculating the similarity, the appearance features of the skin type similar to the known skin type of the skin image to be recognized can be screened out, which provides data support for the subsequent feature extraction algorithm selected according to the appearance features, which is helpful to analyze the tattoo type accurately and improve the recognition efficiency.

S3 Select a feature extraction algorithm of the skin images to be recognized according to the skin appearance features.

In the embodiment of the present application, the skin appearance feature refers to whether there is obvious texture in the skin image to be recognized, and a corresponding feature extraction algorithm is selected according to different skin appearance features.

In detail, the selecting a feature extraction algorithm of the skin images to be recognized according to the skin appearance features includes:
if the skin appearance feature is non-obvious texture, the feature extraction algorithm of the skin images to be recognized without obvious texture is selected as a local binary pattern extraction algorithm;
if the skin appearance feature is obvious texture, the feature extraction algorithm of the skin images to be recognized with obvious texture is selected as a gray level co-occurrence matrix extraction algorithm.

In detail, a Local Binary Pattern (LBP) extraction algorithm is suitable for extracting local features of an image if the skin surface does not have significant texture or detail. LBP can extract small texture changes from local areas of the image, and can capture subtle differences in skin.

If the skin surface has obvious texture (such as wrinkles, pores, etc.), the Gray Level Co-occurrence Matrix (GLCM) extraction algorithm can effectively extract spatial texture information from texture-rich images, including texture features such as contrast, energy, uniformity, etc.

In the case of no obvious texture on the skin surface, the local binary pattern extraction algorithm can extract useful texture information by simple binarization operation, avoiding the complex calculation. In the complex texture skin images, the gray level co-occurrence matrix extraction algorithm can provide richer and more accurate texture information, and help to better distinguish different skin features. By selecting different algorithms according to the skin surface features, the key information which is helpful to the skin type recognition can be extracted better, and the subsequent classification or recognition effect can be improved.

S4 Perform pointwise convolution and depthwise convolution on the skin image to be recognized according to the selected feature extraction algorithm to obtain a tattoo probability of each skin image to be recognized.

In the embodiments of the present application, a tattoo probability of each skin image to be recognized is obtained by a preliminary screening model using MobileNet to judge whether there is a tattoo-containing image or a suspected tattoo/scar image in the skin image to be recognized, and performing bi-classification on the skin image to be recognized.

In detail, the performing pointwise convolution and depthwise convolution on the skin image to be recognized according to the selected feature extraction algorithm to obtain a tattoo probability of each skin image to be recognized includes:
an appearance feature label is generated using the skin appearance feature;
the skin image to be recognized is performed feature extraction according to the selected feature extraction algorithm to obtain a texture feature of each skin image to be recognized;
a predicted label of the texture feature is generated using a preset preliminary screening model;
a binary cross-entropy loss function is generated using the appearance feature label and the predicted label;
the binary cross-entropy loss function is minimized to obtain a minimum loss function;
the preset preliminary screening model is optimized using the minimum loss function to obtain a first screening model;
the skin image to be recognized is adjusted using a preset resolution factor to obtain an updated skin image;
a first convolution kernel is generated using a preset depthwise convolution kernel and a preset width factor;
a first stride is acquired, and each pixel value in the updated skin image is performing weighted averaging one by one using the first screening model according to the first stride and the first convolution kernel to obtain a plurality of convolution pixel values;
a first convolution image is generated using the convolution pixel values; and
the first convolution image and a preset pointwise convolution kernel are performed weighted combination to obtain a tattoo probability of each first convolution image.

In detail, the skin type labels include: normal skin (e.g., healthy skin without any lesions), tattoo (tattoo patterns on the skin), scar (scars after skin injury), and mixed features, etc., labels for each skin type image are generated according to the skin type.

In detail, the skin image to be recognized is performed feature extraction according to the selected feature extraction algorithm to obtain a texture feature of each skin image to be recognized, where a local binary pattern extraction algorithm selected by the skin image to be recognized without obvious texture is provided, and the specific steps are: the skin image to be recognized is grayed, the grayed skin image to be recognized is divided into a plurality of regions, and for each pixel in each small window, the pixel is selected as a central point, and surrounding eight neighboring pixel s are configured to generate a binary pattern. An 8-bit binary value is generated based on the comparison of the gray value of each neighboring pixel with the gray value of the center pixel. If the gray value of the neighboring pixel is greater than or equal to the gray value of the center pixel, the position is 1, otherwise it is 0. The resulting binary number is converted to a decimal number, which represents an LBP value of a small region. The frequency of all LBP values is counted and a histogram of the LBP features is generated. This histogram represents the texture features of the skin image to be recognized.

A gray level co-occurrence matrix extraction algorithm for selecting a skin image to be recognized with an obvious texture, and the specific steps thereof are: a skin image to be recognized is grayed, a direction and a distance between each pixel in the skin image to be recognized after the graying are defined, a gray level co-occurrence matrix is constructed by counting co-occurrence frequencies of gray level value pairs in the image at a specified distance and direction, and texture features of the skin image to be recognized are calculated via the gray level co-occurrence matrix, including: contrast, homogeneity, etc.

In detail, a binary cross-entropy loss function is generated using the appearance feature label and the predicted label, and the calculation formula is as follows:

$$L = - [ y log ( \hat{y} ) + ( 1 - y ) log ( 1 - \hat{y} )$$

where y represents an appearance feature label, and ŷ represents a predicted label.

In detail, the minimizing the binary cross-entropy loss function to obtain a minimum loss function includes:
a first gradient is calculated using the appearance feature label and the predicted label;
a parameter weight of a preset preliminary screening model is acquired, and a second gradient of the parameter weight is calculated using the first gradient and the predicted label;
a final gradient of the binary cross-entropy loss function is generated according to the second gradient;
the final gradient is iterated using a preset learning rate to obtain a minimum weight; and
the binary cross-entropy loss function is adjusted using the minimum weight to obtain a minimum loss function.
the binary cross-entropy loss function is minimized in detail to obtain a minimum loss function, where the calculation formula is as follows:

$$\frac{\partial L}{\partial \hat{y}} = - \frac{y}{\hat{y}} + \frac{1 - y}{1 - \hat{y}}$$

where y represents an appearance feature label, ŷ represents a predicted label, and

$$\frac{\partial L}{\partial \hat{y}}$$

represents a first gradient.

$$\frac{\partial L}{\partial w} = \frac{\partial L}{\partial \hat{y}} * \frac{\partial \hat{y}}{\partial w}$$

where

$$\frac{\partial L}{\partial \hat{y}}$$

represents a first gradient, ŷ represents a predicted label, L represents a binary where cross-entropy loss function, w represents a parameter weight of a preset preliminary screening model, and

$$\frac{\partial L}{\partial w}$$

represents a second gradient.

$$\frac{\partial \hat{y}}{\partial w} = \hat{y} ( 1 - \hat{y} ) * x$$

$$\frac{\partial L}{\partial w} = ( \hat{y} - y ) * x$$

where y represents an appearance feature label, ŷ represents a predicted label, L represents a binary cross-entropy loss function, w represents a parameter weight of a preset preliminary screening model, and x represents a skin image to be recognized.

$${w}_{1} = w - η \frac{\partial L}{\partial w}$$

where w represents a parameter weight of a preset preliminary screening model,

$$\frac{\partial L}{\partial w}$$

represents a second gradient, and n represents a preset learning rate. By updating the parameter weights repeatedly, the binary cross-entropy loss function is gradually reduced until it converges, and the minimum loss function is generated according to the parameter weights at the convergence.

In detail, the input image size for MobileNet is typically 224×224 or 299×299, the collected skin image to be recognized is adjusted to a consistent size, and a preset resolution factor is configured to adjust the skin image to be recognized to obtain an updated skin image, and the calculation formula is as follows:

$${p}_{2} = β {p}_{1}$$

$${q}_{2} = β {q}_{1}$$

where (p₁, q₁) represents a pixel of a skin image to be recognized, β represents a preset resolution factor, and (p₂, q₂) represents a pixel of an updated skin image.

In detail, assuming that the depthwise convolution kernel has a size of 3*3*3 and a width factor of 2, the generated first convolution kernel is a convolution kernel of 3*3*6. The width factor scales the size of the network by adjusting the number of convolution kernels for each layer of the network. The width factor is typically set to a floating value between 0 and 1, which determines the number of channels used in the convolution operation. For example, if the width factor is 0.5, the number of channels per layer in the network will be reduced by half. If the width factor is 1, the number of channels of the network remains the same.

In detail, the size of the first convolution kernel is M*N, each pixel in the updated skin image is (p₂, q₂), and the weight of the first convolution kernel is K(m₁, n₁), each pixel value in the updated skin image is performed weighted averaging with the first convolution kernel one by one according to the first stride by using the first screening model to obtain a plurality of convolution pixel values, and the calculation formula is as follows:

$$C ( {p}_{3} , {q}_{3} ) = {\sum }_{{m}_{1} = 1}^{M} {\sum }_{{n}_{1} = 1}^{N} K ( {m}_{1} , {n}_{1} ) * Q ( {p}_{2} + {m}_{1} - 1 , {q}_{2} + {n}_{1} - 1 )$$

where M and N represent a size of the first convolution kernel, (p₂, q₂) represents each pixel in the updated skin image, K(m₁, n₁) represents a weight of the first convolution kernel, and Q represents an area in the updated skin image. The calculated convolution result is filled into a corresponding pixel to generate a new first convolution image.

In detail, the first convolution image and a preset pointwise convolution kernel are weighted and combined, and the calculation formula is as follows:

$$Y ( {p}_{4} , {q}_{4} ) = {\sum }_{{m}_{2} = 1}^{{M}_{T}} {\sum }_{{n}_{2} = 1}^{{N}_{T}} {K}_{T} ( {m}_{2} , {n}_{2} ) * F ( {p}_{3} + {m}_{2} - 1 , {q}_{3} + {n}_{2} - 1 )$$

where M_{T} and N_{T} represent the size of the preset pointwise convolution kernel, (p₃, q₃) represents each pixel in the first convolution image, K_{T}(m₂, n₂) represents the weight of the preset pointwise convolution kernel, and F represents a region in the first convolution image. The calculated convolution results are further normalized to a range of 0 to 1 by the activation function, resulting in a tattoo probability for each first convolution image.

Through the multi-level convolution and deep learning model optimization, the accurate skin image recognition, especially tattoo detection and probability evaluation is realized. The skin type image is configured to generate labels, combined with the preliminary screening model to predict the skin image labels, and the model parameters are optimized by minimizing the binary cross-entropy loss function, so as to improve the recognition accuracy. By normalizing and adjusting the resolution factor, the consistency of the image is maintained at different resolutions, which enhances the adaptability of the model to the changes of image quality. The combination of pointwise convolution and depthwise convolution further improves the prediction accuracy of tattoo probability. Through multi-level optimization and refinement processing, it not only improves the recognition accuracy, but also enhances the robustness and universality of the model.

S5 Judge whether a tattoo probability is less than or equal to a preset probability threshold.

In the embodiments of the present application, a tattoo probability of each skin image to be recognized is compared with a preset probability threshold, and if the tattoo probability is less than or equal to a preset probability threshold, a judgment result that the skin type of the skin image to be recognized, of which the tattoo probability is less than or equal to the probability threshold, is not a tattoo is obtained.

If the tattoo probability is greater than the probability threshold, S6 is performed, the skin images to be recognized with a tattoo probability of being greater than the probability threshold is converted into a sequence of the skin to be recognized; and

In the embodiments of the present application, a VITmodel is configured to perform further detail recognition on the skin image to be recognized with a tattoo probability greater than the probability threshold, to obtain more accurate skin features, thereby reducing the computing resource requirements and improving the recognition efficiency and accuracy.

In detail, the converting the skin images to be recognized with a tattoo probability of being greater than the probability threshold into a sequence of the skin to be recognized includes:
the first convolution image is segmented according to a preset block size to obtain a plurality of convolution blocks;
each of the convolution blocks is converted into a one-dimensional vector by linear mapping; and
a location encoding of each of the convolution blocks is acquired, and the location encoding is added to a corresponding one-dimensional vector of each of the convolution blocks to obtain a sequence of the skin to be recognized.

In detail, each convolution block is mapped by the linear projection layer to a fixed vector dimension (e.g., 768 dimensions), which determines the feature space processed in the subsequent Transformer model. By location encoding, location information is added to each one-dimensional vector, which ensures that the model can understand the position relationship among the convolution blocks. The linearly mapped one-dimensional vector and the location encoding are combined to obtain one long vector sequence. The long vector sequence constitutes an input sequence of the VIT model, i.e., the sequence of the skin to be recognized.

By dividing the image into smaller convolution blocks and generating one-dimensional vectors, the VIT model can effectively capture local features, thus avoiding the limitations of feature expression that traditional convolution neural networks may have. By adding location encoding, the model can preserve the spatial information of each convolution block, so that VIT can efficiently process complex tattoo details and extract accurate skin features, which helps to provide more accurate results in tattoo detection and skin lesion identification, especially when dealing with images with subtle differences, it can improve the robustness and accuracy of tattoo classification and recognition.

S7 Acquire a tattoo classification label, and perform feature recognition on the sequence of the skin to be recognized using the tattoo classification label to obtain a tattoo classification result.

In the embodiments of the present application, the tattoo classification labels include: cosmetic: configured to cover scars; common aesthetics: common artistic/cultural/fashion tattoos; violent/extreme: containing bloody, extreme symbols or gang signs, etc.; other customized labels (such as religious symbols, personal commemorations, etc.).

In detail, the performing feature recognition on the sequence of the skin to be recognized using the tattoo classification label to obtain a tattoo classification result includes:
the tattoo classification label is added to the sequence of the skin to be recognized to obtain an updated skin sequence;
a relationship between each vector in the updated skin sequence is captured to obtain a correlation among each vector;
the updated skin sequence is performed full connection according to the correlation to obtain a plurality of tattoo classification output values;
the tattoo classification output value is optimized using a preset activation function to obtain a tattoo classification probability of each updated skin sequence; and
the tattoo classification result for each updated skin sequence is generated according to the tattoo classification probability.

In detail, the tattoo classification label and the sequence of the skin to be recognized are sequentially concatenated together to form a new updated skin sequence. The relationship between each vector in the updated skin sequence is captured by the multi-head self-attention mechanism to obtain the correlation among respective vectors.

In detail, the VIT model includes a multilayer perceptron module, typically consisting of a full connection layer, an activation function, and another full connection layer. The multilayer perceptron module is responsible for further processing of the updated skin sequence to output a vector equal to the number of categories (each dimension corresponds to the probability distribution of a category).

In detail, the activation function is a Softmax function, and the calculation formula is as follows:

$$Soft max ( {z}_{a} ) = \frac{{e}^{{z}_{a}}}{{\sum }_{b} {e}^{{z}_{b}}} ( b = 1 , 2 , 3 , … , k )$$

where zₐ represents the a^{th} tattoo classification output value, z_{b} represents the b^{th} tattoo classification category, and k represents the number of tattoo classification output values.

The tattoo classification output value is converted into the tattoo classification probability of each updated skin sequence via the Softmax activation function, and the features of the corresponding tattoo classification are acquired according to the tattoo classification probability to finally obtain the skin feature.

Using the tattoo classification label to perform feature recognition on the sequence of the skin to be recognized can effectively improve the accuracy and reliability of the skin feature recognition. By combining the tattoo classification label with the updated skin sequence, the system is able to more accurately capture the relationship between each vector to better understand the correlation of the skin features. The full connection operation and activation function optimization further improve the efficiency and accuracy of the recognition process, and the final generated tattoo classification probability can provide clearer and more detailed information for the subsequent skin feature analysis, which is helpful to achieve more efficient skin feature recognition and tattoo classification.

It should be understood that the size of the sequence numbers of the steps in the above embodiments is not meant to imply a sequence of carrying out these steps which should be determined by their function and inherent logic, and should not be construed as limiting the implementation of the embodiments of the present application in any way.

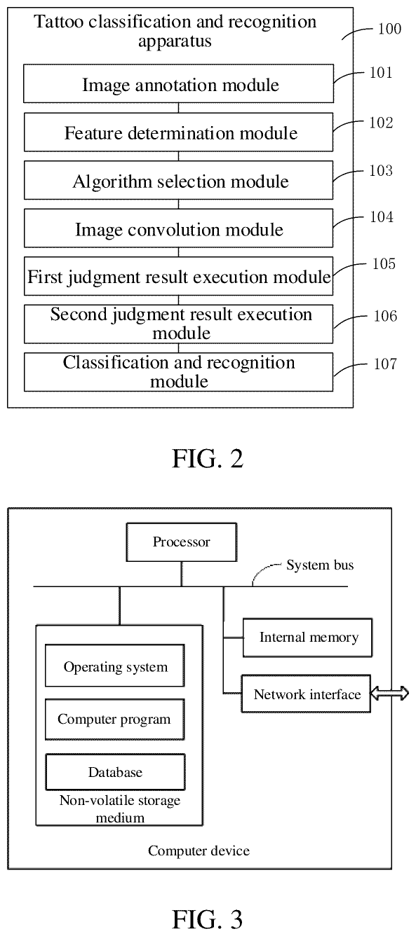

As shown in FIG. 2, FIG. 2 is a functional block diagram showing a tattoo classification and recognition apparatus according to an embodiment of the present application.

In one embodiment of the present disclosure, a tattoo classification and recognition apparatus is provided, which corresponds one-to-one to the tattoo classification and recognition method of the above-described embodiment. As shown in FIG. 2, the tattoo classification and recognition apparatus 100 can be installed in an electronic device, and according to the implemented functions, the tattoo classification and recognition apparatus 100 includes an image annotation module 101, a feature determination module 102, an algorithm selection module 103, an image convolution module 104, a first judgment result execution module 105, a second judgment result execution module 106 and a classification and recognition module 107. Each functional module is described in detail as follows:
an image annotation module 101 configured to acquire a plurality of types of skin image data, and performing type annotation on the skin image data to obtain skin type images;
a feature determination module 102 configured to acquire a plurality of skin images to be recognized, and determining skin appearance features of the skin images to be recognized according to the skin type images;
an algorithm selection module 103 configured to select a feature extraction algorithm of the skin images to be recognized according to the skin appearance features;
an image convolution module 104 configured to perform pointwise convolution and depthwise convolution on the skin image to be recognized according to the selected feature extraction algorithm to obtain a tattoo probability of each skin image to be recognized;
a first judgment result execution module 105 configured to, if the tattoo probability is less than or equal to a preset probability threshold, obtaining a judgment result that the skin type of the skin image to be recognized, of which the tattoo probability is less than or equal to the probability threshold, is not a tattoo;
a second judgment result execution module 106 configured to, if the tattoo probability is greater than the probability threshold, converting a skin image to be recognized which is greater than the probability threshold into a sequence of the skin to be recognized; and
a classification and recognition module 107 configured to acquire a tattoo classification label, and performing feature recognition on the sequence of the skin to be recognized using the tattoo classification label to obtain a tattoo classification result.

In one embodiment, when performing type annotation on the skin image data to obtain skin type images, the image annotation module 101 is configured to:
converting the skin image data into a skin grayscale image;
performing Gaussian smoothing on the skin grayscale image to obtain a smoothed grayscale image;
calculating a horizontal gradient and a vertical gradient of each pixel in the smoothed grayscale image;
calculating a gradient magnitude and a gradient direction using the horizontal gradient and the vertical gradient;
judging whether the gradient magnitude of each pixel in the smoothed grayscale image is greater than a preset first threshold one by one in the gradient direction;
if the gradient magnitude of the pixel is greater than the preset first threshold, taking the pixel of which the gradient magnitude is greater than the first threshold as a strong edge;
if the gradient magnitude of the pixel is less than or equal to the first threshold, judging whether the gradient magnitude is less than a preset second threshold;
if the gradient magnitude is less than the second threshold, deleting the pixel of which the gradient magnitude is less than the second threshold;
if the gradient magnitude is greater than or equal to the second threshold, judging whether an adjacent pixel of the pixel of which the gradient magnitude is greater than or equal to the second threshold is the strong edge;
if the adjacent pixel is not the strong edge, deleting the pixel of which the gradient magnitude is greater than or equal to the second threshold;
if the adjacent pixel is the strong edge, taking the pixel of which the gradient magnitude is greater than or equal to the second threshold as a weak edge;
performing an OR operation on the strong edge and the weak edge to obtain a skin feature edge; and
acquiring an annotation rule and a skin type label, and identifying and marking the skin feature edge using the annotation rule and the skin type label to obtain skin type images.

In one embodiment, the image annotation module 101, when performing Gaussian smoothing on the skin grayscale image to obtain a smoothed grayscale image, is configured to:
randomly select one pixel of the skin grayscale image as a first target pixel;
take the adjacent pixel of the first target pixel as a second target pixel;
perform weighted averaging on pixel values of the first target pixel and the second target pixel using a preset Gaussian filter to obtain an updated pixel value; and
generate the smoothed grayscale image using the updated pixel value.

In one embodiment, the image convolution module 104, when performing pointwise convolution and depthwise convolution on the skin image to be recognized according to the selected feature extraction algorithm to obtain a tattoo probability of each skin image to be recognized, is configured to:
generate an appearance feature label using the skin appearance feature;
perform feature extraction on the skin image to be recognized according to the selected feature extraction algorithm to obtain a texture feature of each skin image to be recognized;
generate a predicted label of the texture feature using a preset preliminary screening model;
generate a binary cross-entropy loss function using the appearance feature label and the predicted label;
minimize the binary cross-entropy loss function to obtain a minimum loss function;
optimize the preset preliminary screening model using the minimum loss function to obtain a first screening model;
adjust the skin image to be recognized using a preset resolution factor to obtain an updated skin image;
generate a first convolution kernel using a preset depthwise convolution kernel and a preset width factor;
a first stride is acquired, and each pixel value in the updated skin image is performing weighted averaging one by one using the first screening model according to the first stride and the first convolution kernel to obtain a plurality of convolution pixel values;
generate a first convolution image using the convolution pixel values; and
perform weighted combination on the first convolution image and a preset pointwise convolution kernel to obtain a tattoo probability of each first convolution image.

In one embodiment, the image convolution module 104, when minimizing the binary cross-entropy loss function to obtain a minimum loss function, is configured to:
calculate a first gradient using the appearance feature label and the predicted label;
acquire a parameter weight of a preset preliminary screening model, and calculate a second gradient of the parameter weight using the first gradient and the predicted label;
generate a final gradient of the binary cross-entropy loss function according to the second gradient;
iterate the final gradient using a preset learning rate to obtain a minimum weight; and
adjust the binary cross-entropy loss function using the minimum weight to obtain a minimum loss function.

In one embodiment, the second judgment result execution module 106, when the converting the skin images to be recognized with a tattoo probability of being greater than the probability threshold into a sequence of the skin to be recognized, is configured to:
segment the first convolution image according to a preset block size to obtain a plurality of convolution blocks;
convert each of the convolution blocks into a one-dimensional vector by linear mapping; and
acquire a location encoding of each of the convolution blocks, and add the location encoding to a corresponding one-dimensional vector of each of the convolution blocks to obtain a sequence of the skin to be recognized.

In one embodiment, the classification and recognition module 107, when acquiring a tattoo classification label, and performing feature recognition on the sequence of the skin to be recognized using the tattoo classification label to obtain a tattoo classification result, is configured to:
add the tattoo classification label to the sequence of the skin to be recognized to obtain an updated skin sequence;
capture a relationship between each vector in the updated skin sequence to obtain a correlation among each vector;
perform full connection on the updated skin sequence according to the correlation to obtain a plurality of tattoo classification output values;
optimize the tattoo classification output value using a preset activation function to obtain a tattoo classification probability of each updated skin sequence; and
generate the tattoo classification result for each updated skin sequence according to the tattoo classification probability.

In the present application, for a tattoo classification and recognition method, the accuracy of tattoo classification and recognition is effectively improved by acquiring a plurality of types of skin image data, and performing type annotation on the skin image data to obtain skin type images; acquiring a plurality of skin images to be recognized, and determining skin appearance features of the skin images to be recognized according to the skin type images; selecting a feature extraction algorithm of the skin images to be recognized according to the skin appearance features; performing pointwise convolution and depthwise convolution on the skin image to be recognized according to the selected feature extraction algorithm to obtain a tattoo probability of each skin image to be recognized; if the tattoo probability is less than or equal to a preset probability threshold, obtaining a judgment result that the skin type of the skin image to be recognized, of which the tattoo probability is less than or equal to the probability threshold, is not a tattoo; if the tattoo probability is greater than the probability threshold, converting the skin images to be recognized with a tattoo probability of being greater than the probability threshold into a sequence of the skin to be recognized; and acquiring a tattoo classification label, and performing feature recognition on the sequence of the skin to be recognized using the tattoo classification label to obtain a tattoo classification result. Specific definitions of a tattoo classification and recognition apparatus can be referred to above for the definition of a tattoo classification and recognition method, which will not be described in detail herein. Each of the modules of the tattoo classification and recognition apparatus described above may be implemented in whole or in part by software, hardware, or a combination thereof. The modules may be embedded in hardware or separate from the processor in the electronic device, or may be stored in software in a memory in the electronic device, such that the processor invokes operations corresponding to the modules.

In one embodiment, an electronic device is provided, which may be a server, and an internal block diagram thereof may be as shown in FIG. 3. The electronic device includes a processor, a memory, a network interface, and a database connected by a system bus. The processor of the electronic device is configured to provide computing and control capabilities. The memory of the electronic device includes a non-volatile storage medium and an internal memory. The non-volatile storage medium stores an operating system, computer programs, and a database. The internal memory provides an environment for the operation of the operating system and computer programs in the non-volatile storage medium. The network interface of the electronic device is configured to communicate with an external client via a network connection. The computer program, when executed by a processor, implements the functions or steps of a tattoo classification and recognition method service side.

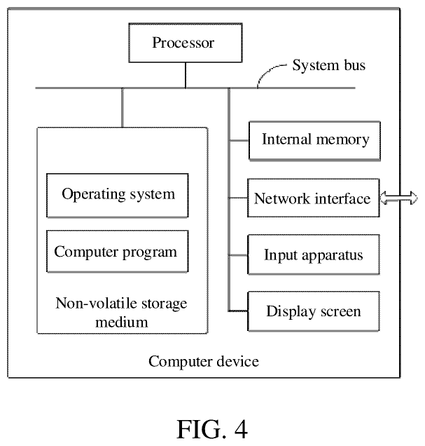

In one embodiment, an electronic device is provided, which may be a client, and an internal block diagram thereof may be as shown in FIG. 4. The electronic device includes a processor, a memory, a network interface, a display screen, and an input apparatus connected by a system bus. The processor of the electronic device is configured to provide computing and control capabilities. The memory of the electronic device includes a non-volatile storage medium, and an internal memory. The non-volatile storage medium stores an operating system and a computer program. The internal memory provides an environment for the operation of the operating system and computer programs in the non-volatile storage medium. The network interface of the electronic device is adapted to communicate with an external server via a network connection. The computer program, when executed by a processor, implements the functions or steps of a client side of a tattoo classification and recognition method.

In one embodiment, an electronic device is provided, which includes a memory, a processor and a computer program stored on the memory and executable on the processor, where the processor, when executing the computer program, performs the following steps of:
acquiring a plurality of types of skin image data, and performing type annotation on the skin image data to obtain skin type images;
acquiring a plurality of skin images to be recognized, and determining skin appearance features of the skin images to be recognized according to the skin type images;
selecting a feature extraction algorithm of the skin images to be recognized according to the skin appearance features;
performing pointwise convolution and depthwise convolution on the skin image to be recognized according to the selected feature extraction algorithm to obtain a tattoo probability of each skin image to be recognized;
if the tattoo probability is less than or equal to a preset probability threshold, obtaining a judgment result that the skin type of the skin image to be recognized, of which the tattoo probability is less than or equal to the probability threshold, is not a tattoo;
if the tattoo probability is greater than the probability threshold, converting the skin images to be recognized with a tattoo probability of being greater than the probability threshold into a sequence of the skin to be recognized; and
acquiring a tattoo classification label, and performing feature recognition on the sequence of the skin to be recognized using the tattoo classification label to obtain a tattoo classification result.

In several embodiments provided by the present application, it is to be understood that the disclosed devices and apparatus may be implemented in other ways. For example, the embodiments of the apparatus described above are merely illustrative, e.g., the partitioning of the modules is merely a logical function partitioning, and additional partitioning may be implemented in practice.

Additionally, in various embodiments of the present application, each functional module may be integrated into a single processing unit, may exist separately as individual physical units, or may have two or more modules integrated into one unit. The above-mentioned integrated units can be realized in the form of hardware, or in the form of hardware plus software functional modules.

The present embodiments are therefore to be considered in all respects as illustrative and not restrictive, the scope of the present application being indicated by the appended claims rather than by the foregoing description, and all changes which come within the meaning and range of equivalency of the claims are therefore intended to be embraced therein. Any reference sign in a claim should not be construed as limiting the claim concerned.

It will be evident to a person skilled in the art that the present application is not limited to the details of the foregoing illustrative embodiments, and that the present application may be embodied in other specific forms without departing from the spirit or essential characteristics thereof.

In some embodiments of the present embodiment, there is provided a computer-readable storage medium having stored thereon a computer program characterized in that the computer program, when executed by a processor, implements the steps of the method of the embodiments described above.

The readable storage medium of the present application stores a computer program, and the computer program, when being executed by a processor of an electronic device, can realize:
acquiring a plurality of types of skin image data, and performing type annotation on the skin image data to obtain skin type images;
acquiring a plurality of skin images to be recognized, and determining skin appearance features of the skin images to be recognized according to the skin type images;
selecting a feature extraction algorithm of the skin images to be recognized according to the skin appearance features;
performing pointwise convolution and depthwise convolution on the skin image to be recognized according to the selected feature extraction algorithm to obtain a tattoo probability of each skin image to be recognized;
if the tattoo probability is less than or equal to a preset probability threshold, obtaining a judgment result that the skin type of the skin image to be recognized, of which the tattoo probability is less than or equal to the probability threshold, is not a tattoo;
if the tattoo probability is greater than the probability threshold, converting the skin images to be recognized with a tattoo probability of being greater than the probability threshold into a sequence of the skin to be recognized; and
acquiring a tattoo classification label, and performing feature recognition on the sequence of the skin to be recognized using the tattoo classification label to obtain a tattoo classification result.

It should be noted that the functions or steps described above with respect to the computer-readable storage medium or the electronic device can be implemented by referring to the relevant description of the server and the client in the foregoing method embodiments, will not be described in detail herein in order to avoid repetition.

The computer-readable storage medium may further store at least one computer-executable program/instruction, where the computer-executable program/instruction is, for example, computer-readable instructions. The computer-readable storage medium includes, but is not limited to, volatile memory and/or non-volatile memory, for example. The volatile memory may for example include a random-access memory (RAM) and/or a cache memory (cache) etc. The computer-readable storage medium may include, for example, a read-only memory (ROM), a hard disk, a flash memory, etc. For example, a non-transitory computer-readable storage medium may be connected to a computing device such as a computer. Then, when the computing device executes the computer-readable instructions stored on the computer-readable storage medium, various methods described above may be implemented.

In addition, the electronic device may further include (but is not limited to) a data bus, an input/output (I/O) bus, a display, and input/output devices (for example, a keyboard, a mouse, a speaker, etc.), etc.

The processor may communicate with external devices via the I/O bus through wired or wireless networks.

In one embodiment, the at least one computer-executable instruction may also be compiled into or constitute a software product/computer program product, where when one or more computer-executable instructions are executed by the processor, they perform the various functions and/or method steps described in the embodiments of the present technology.

It will be understood by a person skilled in the art that all or part of the flows of the methods of the embodiments described above may be implemented by hardware instructions of a computer program, which may be stored in a non-volatile computer-readable storage medium, and when executed, may include the flows of the embodiments of the methods described above. Any reference to memory, storage, databases, or other media used in the various embodiments provided herein may include, among other things, nonvolatile and/or volatile memory. Non-volatile memory may include read only memory (ROM), programmable ROM (PROM), electrically programmable ROM (EPROM), electrically erasable programmable ROM (EEPROM), or flash memory. Volatile memory may include random access memory (RAM) or external cache memory. By way of illustration and not limitation, RAM is available in many forms such as static RAM (SRAM), dynamic RAM (DRAM), synchronous DRAM (SDRAM), double data rate SDRAM (DDRSDRAM), enhanced SDRAM (ESDRAM), Synchlink, DRAM (SLDRAM), Rambus direct RAM (RDRAM), direct rambus dynamic RAM (DRDRAM), and a memory bus dynamic RAM (RDRAM) or the like.

It will be clear to a person skilled in the art that, for convenience and conciseness of description, only the above-mentioned division of functional units and modules is exemplified, and in practical applications, the above-mentioned allocation of functions can be performed by different functional units and modules, i.e. dividing the internal structure of the apparatus into different functional units or modules, as required, to perform all or part of the functions described above.

In the embodiments provided by the present disclosure, it should be understood that the disclosed apparatus and method may also be implemented in other ways. The above-described apparatus embodiments are merely illustrative. For example, the flowcharts and block diagrams in the accompanying drawings show possible implementation architectures, functions and operations of the apparatuses, methods and computer program products according to various embodiments of the present disclosure. In this regard, each block in the flowchart or block diagrams may represent a module, segment, or portion of code, which includes one or more executable instructions for implementing the specified logical functions. In some alternative implementations, the functions noted in the blocks may occur out of the order noted in the figures. For example, two consecutive blocks may in fact be executed substantially in parallel, and they may sometimes be executed in the reverse order, depending on the functionality involved. It is also noted that each block of the block diagrams and/or flowchart illustrations, and combinations of blocks in the block diagrams and/or flowchart illustrations, can be implemented by special purpose hardware-based apparatuses which carry out the specified functions or acts, or combinations of special purpose hardware and computer instructions.

The terms “includes”, “including”, or any other variation thereof in the disclosure are intended to cover a non-exclusive inclusion, such that a process, method, article, or devices that includes a list of elements does not include only those elements but may include other elements not expressly listed or inherent to such process, method, article, or device. An element proceeded by the phrase “includes a . . . ” does not, without more constraints, preclude the existence of additional identical elements in the process, method, article, or device that includes the element.

The above-described embodiments are only configured to illustrate the technical solutions of the present application and not to limit it. Although the present application has been described in detail referring to the foregoing embodiments, a person skilled in the art should understand that they can still modify the technical solutions described in the foregoing embodiments or equivalently replace some of the technical features. Such modifications or replacements shall not cause the essence of the corresponding technical solutions to depart from the spirit and scope of the technical solutions of the embodiments of the present application, and shall all be included within the protection scope of the present application.

It should be noted that if any non-company software tools or components appear in the embodiments of the present application, they are only configured to illustrative purposes and do not represent actual usage.

What is claimed is:

1. A tattoo classification and recognition method, comprising the following steps of:
acquiring a plurality of types of skin image data, and performing type annotation on the skin image data to obtain skin type images;
acquiring a plurality of skin images to be recognized, and determining skin appearance features of the skin images to be recognized according to the skin type images;
selecting a feature extraction algorithm of the skin images to be recognized according to the skin appearance features;
performing pointwise convolution and depthwise convolution on the skin image to be recognized according to the selected feature extraction algorithm to obtain a tattoo probability of each skin image to be recognized;
if the tattoo probability is less than or equal to a preset probability threshold, obtaining a judgment result that the skin type of the skin image to be recognized, of which the tattoo probability is less than or equal to the probability threshold, is not a tattoo;
if the tattoo probability is greater than the probability threshold, converting the skin images to be recognized with a tattoo probability of being greater than the probability threshold into a sequence of the skin to be recognized; and
acquiring a tattoo classification label, and performing feature recognition on the sequence of the skin to be recognized using the tattoo classification label to obtain a tattoo classification result.

2. The tattoo classification and recognition method according to claim 1, wherein the step of performing type annotation on the skin image data to obtain skin type images comprises:
converting the skin image data into a skin grayscale image;
performing Gaussian smoothing on the skin grayscale image to obtain a smoothed grayscale image;
calculating a horizontal gradient and a vertical gradient of each pixel in the smoothed grayscale image;
calculating a gradient magnitude and a gradient direction using the horizontal gradient and the vertical gradient;
judging whether the gradient magnitude of each pixel in the smoothed grayscale image is greater than a preset first threshold one by one in the gradient direction;
if the gradient magnitude of the pixel is greater than the preset first threshold, taking the pixel of which the gradient magnitude is greater than the first threshold as a strong edge;
if the gradient magnitude of the pixel is less than or equal to the first threshold, judging whether the gradient magnitude is less than a preset second threshold;
if the gradient magnitude is less than the second threshold, deleting the pixel of which the gradient magnitude is less than the second threshold;
if the gradient magnitude is greater than or equal to the second threshold, judging whether an adjacent pixel of the pixel of which the gradient magnitude is greater than or equal to the second threshold is the strong edge;
if the adjacent pixel is not the strong edge, deleting the pixel of which the gradient magnitude is greater than or equal to the second threshold;
if the adjacent pixel is the strong edge, taking the pixel of which the gradient magnitude is greater than or equal to the second threshold as a weak edge;
performing an OR operation on the strong edge and the weak edge to obtain a skin feature edge; and
acquiring an annotation rule and a skin type label, and identifying and marking the skin feature edge using the annotation rule and the skin type label to obtain skin type images.

3. The tattoo classification and recognition method according to claim 2, wherein the step of performing Gaussian smoothing on the skin grayscale image to obtain a smoothed grayscale image comprises:
randomly selecting one pixel of the skin grayscale image as a first target pixel;
taking the adjacent pixel of the first target pixel as a second target pixel;
performing weighted averaging on pixel values of the first target pixel and the second target pixel using a preset Gaussian filter to obtain an updated pixel value; and
generating the smoothed grayscale image using the updated pixel value.

4. The tattoo classification and recognition method according to claim 1, wherein the step of performing pointwise convolution and depthwise convolution on the skin image to be recognized according to the selected feature extraction algorithm to obtain a tattoo probability of each skin image to be recognized comprises:
generating an appearance feature label using the skin appearance feature;
performing feature extraction on the skin image to be recognized according to the selected feature extraction algorithm to obtain a texture feature of each skin image to be recognized;
generating a predicted label of the texture feature using a preset preliminary screening model;
generating a binary cross-entropy loss function using the appearance feature label and the predicted label;
minimizing the binary cross-entropy loss function to obtain a minimum loss function;
optimizing the preset preliminary screening model using the minimum loss function to obtain a first screening model;
adjusting the skin image to be recognized using a preset resolution factor to obtain an updated skin image;
generating a first convolution kernel using a preset depthwise convolution kernel and a preset width factor;
acquiring a first stride, and performing weighted averaging on each pixel value in the updated skin image one by one using the first screening model according to the first stride and the first convolution kernel to obtain a plurality of convolution pixel values;
generating a first convolution image using the convolution pixel values; and
performing weighted combination on the first convolution image and a preset pointwise convolution kernel to obtain a tattoo probability of each first convolution image.

5. The tattoo classification and recognition method according to claim 4, wherein the step of minimizing the binary cross-entropy loss function to obtain a minimum loss function comprises:
calculating a first gradient using the appearance feature label and the predicted label;
acquiring a parameter weight of a preset preliminary screening model, and calculating a second gradient of the parameter weight using the first gradient and the predicted label;
generating a final gradient of the binary cross-entropy loss function according to the second gradient;
iterating the final gradient using a preset learning rate to obtain a minimum weight; and
adjust the binary cross-entropy loss function using the minimum weight to obtain a minimum loss function.

6. The tattoo classification and recognition method according to claim 1, wherein the step of converting the skin images to be recognized with a tattoo probability of being greater than the probability threshold into a sequence of the skin to be recognized comprises:
segmenting the first convolution image according to a preset block size to obtain a plurality of convolution blocks;
converting each of the convolution blocks into a one-dimensional vector by linear mapping; and
acquiring a location encoding of each of the convolution blocks, and adding the location encoding to a corresponding one-dimensional vector of each of the convolution blocks to obtain a sequence of the skin to be recognized.

7. The tattoo classification and recognition method according to claim 1, wherein the step of performing feature recognition on the sequence of the skin to be recognized using the tattoo classification label to obtain a tattoo classification result comprises:
adding the tattoo classification label to the sequence of the skin to be recognized to obtain an updated skin sequence;
capturing a relationship between each vector in the updated skin sequence to obtain a correlation among each vector;
performing full connection on the updated skin sequence according to the correlation to obtain a plurality of tattoo classification output values;
optimizing the tattoo classification output value using a preset activation function to obtain a tattoo classification probability of each updated skin sequence; and
generating the tattoo classification result for each updated skin sequence according to the tattoo classification probability.

8. An electronic device, comprising: a memory, a processor, wherein the processor is electrically connected to the memory, the memory stores a computer program executable by the at least one processor, the computer program, when executed by the at least one processor, causes the at least one processor to perform the following steps of:
acquiring a plurality of types of skin image data, and performing type annotation on the skin image data to obtain skin type images;
acquiring a plurality of skin images to be recognized, and determining skin appearance features of the skin images to be recognized according to the skin type images;
selecting a feature extraction algorithm of the skin images to be recognized according to the skin appearance features;
performing pointwise convolution and depthwise convolution on the skin image to be recognized according to the selected feature extraction algorithm to obtain a tattoo probability of each skin image to be recognized;
if the tattoo probability is less than or equal to a preset probability threshold, obtaining a judgment result that the skin type of the skin image to be recognized, of which the tattoo probability is less than or equal to the probability threshold, is not a tattoo;
if the tattoo probability is greater than the probability threshold, converting the skin images to be recognized with a tattoo probability of being greater than the probability threshold into a sequence of the skin to be recognized; and
acquiring a tattoo classification label, and performing feature recognition on the sequence of the skin to be recognized using the tattoo classification label to obtain a tattoo classification result.

9. The electronic device according to claim 8, wherein the step of performing type annotation on the skin image data to obtain skin type images comprises:
converting the skin image data into a skin grayscale image;
performing Gaussian smoothing on the skin grayscale image to obtain a smoothed grayscale image;
calculating a horizontal gradient and a vertical gradient of each pixel in the smoothed grayscale image;
calculating a gradient magnitude and a gradient direction using the horizontal gradient and the vertical gradient;
judging whether the gradient magnitude of each pixel in the smoothed grayscale image is greater than a preset first threshold one by one in the gradient direction;
if the gradient magnitude of the pixel is greater than the preset first threshold, taking the pixel of which the gradient magnitude is greater than the first threshold as a strong edge;
if the gradient magnitude of the pixel is less than or equal to the first threshold, judging whether the gradient magnitude is less than a preset second threshold;
if the gradient magnitude is less than the second threshold, deleting the pixel of which the gradient magnitude is less than the second threshold;
if the gradient magnitude is greater than or equal to the second threshold, judging whether an adjacent pixel of the pixel of which the gradient magnitude is greater than or equal to the second threshold is the strong edge;
if the adjacent pixel is not the strong edge, deleting the pixel of which the gradient magnitude is greater than or equal to the second threshold;
if the adjacent pixel is the strong edge, taking the pixel of which the gradient magnitude is greater than or equal to the second threshold as a weak edge;
performing an OR operation on the strong edge and the weak edge to obtain a skin feature edge; and
acquiring an annotation rule and a skin type label, and identifying and marking the skin feature edge using the annotation rule and the skin type label to obtain skin type images.

10. The electronic device according to claim 9, wherein the step of performing Gaussian smoothing on the skin grayscale image to obtain a smoothed grayscale image comprises:
randomly selecting one pixel of the skin grayscale image as a first target pixel;
taking the adjacent pixel of the first target pixel as a second target pixel;
performing weighted averaging on pixel values of the first target pixel and the second target pixel using a preset Gaussian filter to obtain an updated pixel value; and
generating the smoothed grayscale image using the updated pixel value.

11. The electronic device according to claim 8, wherein the step of performing pointwise convolution and depthwise convolution on the skin image to be recognized according to the selected feature extraction algorithm to obtain a tattoo probability of each skin image to be recognized comprises:
generating an appearance feature label using the skin appearance feature;
performing feature extraction on the skin image to be recognized according to the selected feature extraction algorithm to obtain a texture feature of each skin image to be recognized;
generating a predicted label of the texture feature using a preset preliminary screening model;
generating a binary cross-entropy loss function using the appearance feature label and the predicted label;
minimizing the binary cross-entropy loss function to obtain a minimum loss function;
optimizing the preset preliminary screening model using the minimum loss function to obtain a first screening model;
adjusting the skin image to be recognized using a preset resolution factor to obtain an updated skin image;
generating a first convolution kernel using a preset depthwise convolution kernel and a preset width factor;
acquiring a first stride, and performing weighted averaging on each pixel value in the updated skin image one by one using the first screening model according to the first stride and the first convolution kernel to obtain a plurality of convolution pixel values;
generating a first convolution image using the convolution pixel values; and
performing weighted combination on the first convolution image and a preset pointwise convolution kernel to obtain a tattoo probability of each first convolution image.

12. The electronic device according to claim 11, wherein the step of minimizing the binary cross-entropy loss function to obtain a minimum loss function comprises:
calculating a first gradient using the appearance feature label and the predicted label;
acquiring a parameter weight of a preset preliminary screening model, and calculating a second gradient of the parameter weight using the first gradient and the predicted label;
generating a final gradient of the binary cross-entropy loss function according to the second gradient;
iterating the final gradient using a preset learning rate to obtain a minimum weight; and
adjusting the binary cross-entropy loss function using the minimum weight to obtain a minimum loss function.

13. The electronic device according to claim 8, wherein the step of converting the skin images to be recognized with a tattoo probability of being greater than the probability threshold into a sequence of the skin to be recognized comprises:
segmenting the first convolution image according to a preset block size to obtain a plurality of convolution blocks;
converting each of the convolution blocks into a one-dimensional vector by linear mapping; and
acquiring a location encoding of each of the convolution blocks, and adding the location encoding to a corresponding one-dimensional vector of each of the convolution blocks to obtain a sequence of the skin to be recognized.

14. The electronic device according to claim 8, wherein the step of performing feature recognition on the sequence of the skin to be recognized using the tattoo classification label to obtain a tattoo classification result comprises:
adding the tattoo classification label to the sequence of the skin to be recognized to obtain an updated skin sequence;
capturing a relationship between each vector in the updated skin sequence to obtain a correlation among each vector;
performing full connection on the updated skin sequence according to the correlation to obtain a plurality of tattoo classification output values;
optimizing the tattoo classification output values using a preset activation function to obtain a tattoo classification probability of each updated skin sequence; and
generating the tattoo classification result for each updated skin sequence according to the tattoo classification probability.

15. A non-volatile computer-readable storage medium having stored thereon a computer program, wherein the computer program, when executed by one or more processors, causes the one or more processors to perform the following steps of:
acquiring a plurality of types of skin image data, and performing type annotation on the skin image data to obtain skin type images;
acquiring a plurality of skin images to be recognized, and determining skin appearance features of the skin images to be recognized according to the skin type images;
selecting a feature extraction algorithm of the skin images to be recognized according to the skin appearance features;
performing pointwise convolution and depthwise convolution on the skin image to be recognized according to the selected feature extraction algorithm to obtain a tattoo probability of each skin image to be recognized;
if the tattoo probability is less than or equal to a preset probability threshold, obtaining a judgment result that the skin type of the skin image to be recognized, of which the tattoo probability is less than or equal to the probability threshold, is not a tattoo;
if the tattoo probability is greater than the probability threshold, converting the skin images to be recognized with a tattoo probability of being greater than the probability threshold into a sequence of the skin to be recognized; and
acquiring a tattoo classification label, and performing feature recognition on the sequence of the skin to be recognized using the tattoo classification label to obtain a tattoo classification result.

16. The non-volatile computer-readable storage medium according to claim 15, wherein the step of performing type annotation on the skin image data to obtain skin type images comprises:
converting the skin image data into a skin grayscale image;
performing Gaussian smoothing on the skin grayscale image to obtain a smoothed grayscale image;
calculating a horizontal gradient and a vertical gradient of each pixel in the smoothed grayscale image;
calculating a gradient magnitude and a gradient direction using the horizontal gradient and the vertical gradient;
judging whether the gradient magnitude of each pixel in the smoothed grayscale image is greater than a preset first threshold one by one in the gradient direction;
if the gradient magnitude of the pixel is greater than the preset first threshold, taking the pixel of which the gradient magnitude is greater than the first threshold as a strong edge;
if the gradient magnitude of the pixel is less than or equal to the first threshold, judging whether the gradient magnitude is less than a preset second threshold;
if the gradient magnitude is less than the second threshold, deleting the pixel of which the gradient magnitude is less than the second threshold;
if the gradient magnitude is greater than or equal to the second threshold, judging whether an adjacent pixel of the pixel of which the gradient magnitude is greater than or equal to the second threshold is the strong edge;
if the adjacent pixel is not the strong edge, deleting the pixel of which the gradient magnitude is greater than or equal to the second threshold;
if the adjacent pixel is the strong edge, taking the pixel of which the gradient magnitude is greater than or equal to the second threshold as a weak edge;
performing an OR operation on the strong edge and the weak edge to obtain a skin feature edge; and
acquiring an annotation rule and a skin type label, and identifying and marking the skin feature edge using the annotation rule and the skin type label to obtain skin type images.

17. The non-volatile computer-readable storage medium according to claim 16, wherein the step of performing Gaussian smoothing on the skin grayscale image to obtain a smoothed grayscale image comprises:
randomly selecting one pixel of the skin grayscale image as a first target pixel;
taking the adjacent pixel of the first target pixel as a second target pixel;
performing weighted averaging on pixel values of the first target pixel and the second target pixel using a preset Gaussian filter to obtain an updated pixel value; and
generating the smoothed grayscale image using the updated pixel value.

18. The non-volatile computer-readable storage medium according to claim 15, wherein the step of performing pointwise convolution and depthwise convolution on the skin image to be recognized according to the selected feature extraction algorithm to obtain a tattoo probability of each skin image to be recognized comprises:
generating an appearance feature label using the skin appearance feature;
performing feature extraction on the skin image to be recognized according to the selected feature extraction algorithm to obtain a texture feature of each skin image to be recognized;
generating a predicted label of the texture feature using a preset preliminary screening model;
generating a binary cross-entropy loss function using the appearance feature label and the predicted label;
minimizing the binary cross-entropy loss function to obtain a minimum loss function;
optimizing the preset preliminary screening model using the minimum loss function to obtain a first screening model;
adjusting the skin image to be recognized using a preset resolution factor to obtain an updated skin image;
generating a first convolution kernel using a preset depthwise convolution kernel and a preset width factor;
acquiring a first stride, and performing weighted averaging on each pixel value in the updated skin image one by one using the first screening model according to the first stride and the first convolution kernel to obtain a plurality of convolution pixel values;
generating a first convolution image using the convolution pixel values; and
performing weighted combination on the first convolution image and a preset pointwise convolution kernel to obtain a tattoo probability of each first convolution image.

19. The non-volatile computer-readable storage medium according to claim 18, wherein the step of minimizing the binary cross-entropy loss function to obtain a minimum loss function comprises:
calculating a first gradient using the appearance feature label and the predicted label;
acquiring a parameter weight of a preset preliminary screening model, and calculating a second gradient of the parameter weight using the first gradient and the predicted label;
generating a final gradient of the binary cross-entropy loss function according to the second gradient;
iterating the final gradient using a preset learning rate to obtain a minimum weight; and
adjusting the binary cross-entropy loss function using the minimum weight to obtain a minimum loss function.

20. The non-volatile computer-readable storage medium according to claim 15, wherein the step of performing feature recognition on the sequence of the skin to be recognized using the tattoo classification label to obtain a tattoo classification result comprises:
adding the tattoo classification label to the sequence of the skin to be recognized to obtain an updated skin sequence;
capturing a relationship between each vector in the updated skin sequence to obtain a correlation among each vector;
performing full connection on the updated skin sequence according to the correlation to obtain a plurality of tattoo classification output values;
optimizing the tattoo classification output value using a preset activation function to obtain a tattoo classification probability of each updated skin sequence; and
generating the tattoo classification result for each updated skin sequence according to the tattoo classification probability.
